(19) United States
(12) Patent Application Publication
(10) Pub. No.: US 2024/0042777 A1
(43) Pub. Date: Feb. 8, 2024

(54) Full-Face Ballot Printing Using Thermal Technology

(71) Applicant: Clear Ballot Group, Inc., Boston, MA (US)

(72) Inventors: Simon Jarvis, Middleton, MA (US); Adam Meunier, Cumberland, RI (US); Michael Papa, Windham, NH (US); Savio Polini, Wenham, MA (US)

(21) Appl. No.: 17/818,260

(22) Filed: Aug. 8, 2022

(51) Int. Cl. B41J 15/06; B41J 11/70

(52) U.S. Cl. CPC B41J 15/06; B41J 11/70

(57) ABSTRACT

A thermal ballot printer is disclosed for producing double-sided thermal full-face printed voting ballots, comprising: a first thermal print head disposed on a first side of a print path, the print path being configured to receive an end of a roll-fed thermal print medium; a second thermal print head disposed on a second side of a print path; and a cutter disposed on the first side of the print path and configured to cut printed sheets.

### CROSS-REFERENCE TO RELATED APPLICATIONS

None.

### BACKGROUND OF THE INVENTION

Thermal printers are printers that apply energy to an imaging medium (e.g., paper) to cause a state change within or on the paper. By causing a state change on certain portions of the paper, an image is formed. Thermal printers are commonly used in applications such as small-format receipt printers.

In a different subject area, elections are a key area of societal interest that require efficient administration. Voters in many jurisdictions commonly indicate their selections on ballots by making marks on pre-printed ballots; however, it is expensive to print sufficient ballots to support the anticipated turnout for an election. As well, in some jurisdictions voters are accustomed to using electronic voting devices to indicate their selections. These devices provide accessibility options for voters with disabilities and are intuitive for many voters, but their paper trail may be considered less auditable than full-face ballots. Accessible voting systems that have the auditability of hand-marked paper ballots are still an area of active interest.

### BRIEF DESCRIPTION OF THE DRAWINGS

FIG. 1A is an exterior diagram of a ballot marking system, in accordance with some embodiments.

FIG. 1B is a schematic diagram of a ballot marking system, in accordance with some embodiments.

FIG. 2 is a printer schematic design, in accordance with some embodiments.

FIG. 3 is a printer mechanism schematic design, in accordance with some embodiments.

FIGS. 4A, 4B, and 4C are alternative views of a paper axle hold down lock design, in accordance with some embodiments.

FIG. 4D is a perspective view of a paper roll brake design, in accordance with some embodiments.

FIG. 5 is a paper cross section schematic design, in accordance with some embodiments.

### SUMMARY

While thermal printers are known in the art, the inventors have understood and appreciated the need for a double-sided thermal ballot printing system.

The inventors have contemplated a novel combination of a large format direct thermal printing paper, in conjunction with a particular configuration of direct thermal printer, in some embodiments.

In a first embodiment, a thermal ballot printer is disclosed for producing double-sided full-face thermal printed ballots, comprising: a first thermal print head disposed on a first side of a print path, the print path being configured to receive an end of a roll-fed thermal print medium; a second thermal print head disposed on a second side of a print path; and a cutter disposed on the first side of the print path and configured to cut printed sheets.

The print path may be configured to accept a roll-fed thermal print medium of between 7″ and 9″ in width. The thermal ballot printer may further comprise a paper roll brake configured to hold a roll of thermal paper in a first configuration suitable for use by the printer in an operational mode; and in a second locked configuration suitable for secure transport of the roll of thermal paper while mounted to the locking paper roll holder. The locking paper roll holder may further comprise a paper roll brake configured to make contact with a roll of thermal paper to prevent the roll of thermal paper from rotating. A paper roll axle hold-down may also be provided that is configured to maintain physical coupling between a mounting axle for a roll of thermal paper with the thermal ballot printer while permitting rotation for the roll of thermal paper during operation of the thermal ballot printer.

The thermal ballot printer may be electrically coupled to a battery system equipped to provide one or both of battery backup power or battery operating power to the thermal ballot printer. The thermal ballot printer may further comprise a digital interface for receiving a ballot printer description file of two or more pages in length and a processor for assigning a first page of the received ballot printer description file to the first thermal print head and for assigning a second page of the received ballot printer description file to the second thermal print head.

The first thermal print head may be disposed opposite a first roller platen on the second side of the print path and the second thermal print head may be disposed opposite a second roller platen on the first side of the print path. The thermal ballot printer may further comprise a firmware configured to receive instructions to heat the first thermal print head to a first state-change temperature during operation and the second thermal print head to a second state-change temperature during operation. The first state-change temperature and the second state-change temperature may be configured to enable printing of double-sided ballots in synchronized fashion. The first thermal print head and the second thermal print head may be direct thermal print heads. The thermal ballot printer may further be configured to communicate with software, the software for receiving a voter's intent via one or more of a touchscreen and an assistive input device, and for rendering a printed ballot image.

In a second embodiment, a ballot marking system is disclosed, comprising: an enclosure; a user-operated touchscreen device for enabling a user to indicate vote selections; and a double-sided full-face thermal ballot printer.

The user-operated touchscreen device may be operable by a voter to print a filled-in ballot reflecting the vote selections using the double-sided full-face thermal ballot printer. The user-operated touchscreen device may be operable by an election administrator to print a blank ballot using the double-sided full-face thermal ballot printer. The ballot marking system may further comprise a secure paper roll holder with two configurations, the secure paper roll holder having a first configuration for feeding a roll of double-sided thermal paper into the double-sided full-face thermal ballot printer, and a second configuration for securely holding the roll of double-sided thermal paper without unspooling during transport, the second configuration The ballot marking system may further comprise a brake. The ballot marking system may further comprise a battery for battery backup-based operation of the ballot marking system. The ballot marking system may further comprise a cutter for cutting ballots emitted by the double-sided full-face thermal ballot printer, and a slot in the enclosure situated at an end of a paper path of the double-sided full-face thermal ballot printer. The ballot marking system may further comprise at least one assistive input device for enabling a voter to indicate vote selections, and The at least one assistive input device comprises one or more of a keypad, a rocker paddle, and a sip and puff device. The double-sided full-face thermal ballot printer configured to use a roll of double-sided direct thermal paper having a width of 8.5″.

### DETAILED DESCRIPTION

The inventors have determined that there is a need for double-sided thermal full-face printed ballots, and have developed a voting system for use therewith. A ballot marking system with an included printer module is described, in accordance with some embodiments. Marked ballots representing a voter's vote selections are enabled to be printed, in some embodiments. On-demand printing of unmarked ballots can also be achieved to support voting by hand-marked ballot. The use of fully marked ballots provides a valuable safeguard and audit trail for voting. Hand-marked or machine-marked ballots are both used in election administration, and both are facilitated using the ballot printing machine described herein. A ballot marking system incorporating a double-sided thermal printer, as well as paper handling mechanisms and appropriate paper relevant thereto, are herein disclosed and described.

It is notable that the requirements for ballot printing exceed receipt printing: Consistency across the page (more a function of the paper and its layer of thermal reactive coating) is important, as optical scanners are typically used. The use of machine-marked printed ballots greatly enhances machine readability, in some embodiments. Hand-marked and machine-marked ballots are both supported, in some embodiments. The use of ballots as described herein are contemplated for both central count or hand-feed optical scanners. However, ballots are ideally both machine-readable and human-verifiable. Full-face ballots are more human-verifiable than summary ballots because voter intent is expressed in a human-readable format that is also tabulated by the tabulation software, whereas it is common in summary ballots for a machine to tabulate machine-readable representations of the voter intent such as barcodes QR codes, which are less human-verifiable.

Direct thermal printing also offers many advantages compared to other printing technologies, including greater durability, fewer moving parts, no ink, toner, or ribbon consumables. Additionally, the ability to print both sides simultaneously and with minimal “warm-up” time provides a significant increase in the speed of printing. Printing from a paper roll also supports printing a range of ballot lengths, as detailed below, without the need to load paper of the appropriate size in the printer. Paper ballots are generally subject to record retention requirements even after the votes have been tabulated. The drawbacks of thermal printing are generally focused around the durability of the resulting print, as heat and light can cause the image to degrade. However, the inventors have identified that it is advantageous to use thermal paper that meets or exceeds such record retention requirements, provided that the pre- and/or post-imaging ballots are stored in a temperate, indoor controlled environment in accordance with the paper's specifications. The specialized paper required for thermal printing is itself a security measure, ensuring that counterfeit ballots are more easily spotted and that election security can be maintained by requiring the special paper. As well, much less energy is used than with laser printing, which is a desirable characteristic especially when battery backup capability is desired.

As used herein, the following terms shall have the following meanings. The terms “double-sided full-face thermal ballot printer,” “full-face thermal ballot printer,” “thermal ballot printer,” and permutations thereof shall be understood to have substantially the same meaning as one another. The term “ballot marking system” is understood to refer to an AIO computer module and thermal printer as described substantially herein, mounted in a case, preferably an ATA case, optionally provided together with additional components as described herein. The term “embedded printer” is understood to refer to a printer component without the enclosure. The term “printer module” is understood to refer to a thermal printer in its enclosure. The term “enclosure” is understood to refer to an exterior of the printer assembly. The term “setup case” is understood to refer to an ATA (Air Transport Association) case or other durable case in which an AIO computer module and printer are mounted, and the terms “setup case lid” and “setup case body” are understood to refer to the top and bottom portion of a setup case. The term “All-in-One (AIO) computer module” is understood to refer to a computer module of the voting system, which may include one or more of: a touchscreen interface; a touchscreen; a CPU; a battery; and other accessibility provisions. The term “full-face ballot” is understood to refer to a printed ballot from a ballot marking system that has the same content and layout as a preprinted ballot for hand-marked voting, including non-selected choices, in contrast to a summary ballot, which only lists the choices selected by the voter. The term “jurisdiction” is understood to refer to a locality that administers elections, which may include multiple precincts or election districts having the same requirements. The term “ballot marking or printing application” is understood to refer to software that produces the output of a marked or unmarked ballot to be printed. In addition, where required for consistency or context, the terms in this paragraph may also retain their commonly understood meanings.

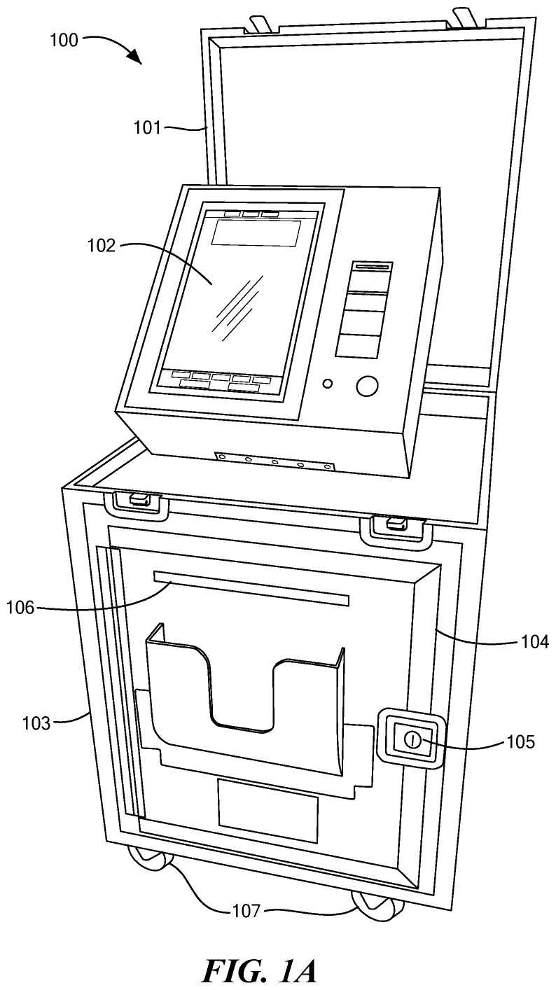

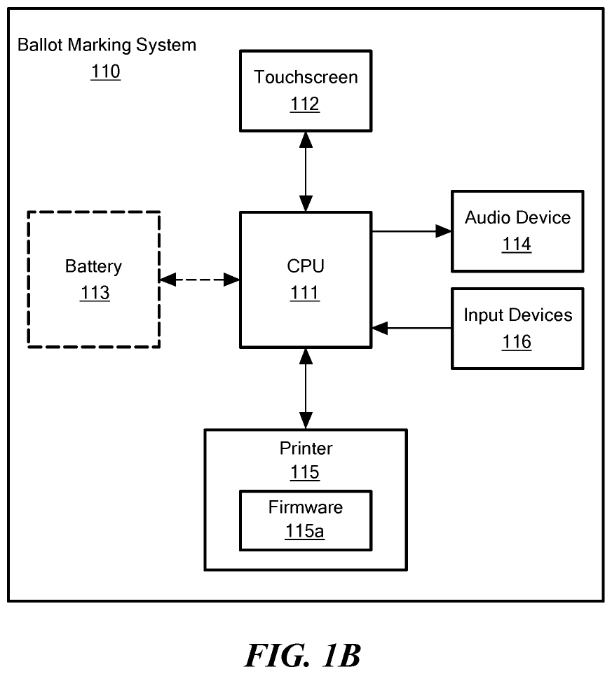

FIG. 1A is an exterior diagram of a ballot marking system, in accordance with some embodiments. Ballot marking system 100 is configured to be operated by an individual voter. A setup case is designed so that the ballot marking system can be operated by voters in either a standing or sitting position. The setup case lid 101 can be closed to protect the AIO voting system during transport and opened during operation. An AIO computer module 102 is equipped with software that presents voting options to an individual voter so that he or she can indicate his or her vote selections. AIO computer module 102 is on hinges or rails, in some embodiments, such that when setup case lid 101 is closed it is folded flat in a protected orientation, but when setup case lid 101 is opened it is configured in a vertical orientation for operation by the individual voter. AIO computer module 102 is optionally position-adjustable.

One or both of AIO computer module 102 and lid 101 are mounted to setup case body 103, in some embodiments. One or more rear hinges (not shown) connects setup case lid 101 and setup case body 103. Setup case lid 101 and setup case body 103 are made of a durable material such as a strong plastic or wood, or other material having favorable structural characteristics, with metal, or other robust material, hardware for protecting any areas that come into regular and/or heavy contact with one other or external forces, such as interfaces between setup case lid 101 and setup case body 103, or edges of the case material in order to preserve structural rigidity and integrity.

Setup case body 103 may have a top surface to which AIO computer module 102 is mounted. Setup case body 103 may be substantially hollow and may enclose a printer module, which is accessible by opening access door 104. Access door 104 includes locking mechanism 105, which may be any locking mechanism known in the art such as a butterfly turn latch. Locking mechanism 105 may be secured with a padlock or other secure locking mechanism for safety and security of election administration, including the application of tamper-evident seals. Access door 104 also includes slot 106, which is aligned with the printer module such that it enables the printer module to emit a sheet of paper to the individual voter. In some embodiments, slot 106 may be configured to emit paper in an upward direction toward the voter. In some embodiments, slot 106 may be configured to emit paper in a horizontal direction toward the voter. Setup case body 103 may also have attached wheels 107 to enable election administrators to move the ballot marking system within, into, or out of a voting area. Configurations of the ballot marking system may be configured to meet the accessibility and usability guidelines of, e.g., the Americans with Disabilities Act (ADA) or the U.S. Election Assistance Commission (EAC) Voluntary Voting System Guidelines (VVSG), and various additional physical configurations of setup case lid 101 and setup case body 103 are also enabled in certain embodiments, such as configurations with a lower height, with a printer in a different location, and/or with a recessed volume directly in front of the ballot marking system so as to enable a wheelchair operator to comfortably operate the ballot marking system while seated directly in front of the machine.

FIG. 1B is a schematic diagram of a ballot marking system, in accordance with some embodiments. Ballot marking system 110 is controlled by CPU 111, which is in communication with touchscreen 112, optional battery 113, audio device 114, printer 115 (with firmware 115a). Additional input devices, shown as 116, can be used for accessible operation of the ballot marking system, such as keypads, rocker paddles, or sip-and-puff devices, in some embodiments. The CPU 111 may be any appropriate CPU, such as an ARM processor on a system-on-module (SOM) with internal flash storage, and may also be disposed on a logic board with additional features and functions, such as a USB controller, etc., in some embodiments. The touchscreen 112 may be sized to comfortably allow a user to operate during election administration, preferably between 10″ and 16″.

Battery 113 is optional, in some embodiments, but it is desirable to have a battery that is able to provide backup for mission-critical elections administration. In an elections context, battery backup is often a requirement of the industry. Laser printers use a great deal of power; thermal printing is desirable as it is more efficient and consistent in terms of its energy consumption. Two hours or more of battery backup operation is enabled assuming a moderate duty cycle, in some embodiments. In some embodiments, ballot marking system 110 and printer 115 may operate on mains power with battery backup; in other embodiments, ballot marking system 110 and printer 115 may operate with battery power as its primary power source. CPU 111 may have at least the ability to monitor battery level, in some embodiments.

Audio device 114 may be a speaker, a headphone jack, or both, and may provide assistive features in compliance with the ADA or VVSG as well as providing audible alerts. Touchscreen 114 and additional input devices 116 may also provide assistive features. The printer is described further herein and receives ballot images from the CPU to be printed via the firmware 115a. Firmware 115a may be modified using CPU 111.

In operation, a voting administrator may move the ballot marking system 100 to its desired position in the polling location, unlock and open the setup case, configure the system via the touchscreen or other assistive input devices, plug in an electrical plug for operation on mains power (the battery, if installed, is understood to be used primarily for power failures), and perform any preliminary procedures before voting commences. An individual voter operates the ballot marking system to indicate their vote selections, receives a printed ballot from slot 106 with his or her vote choices filled in, and inserts the printed ballot into a ballot scanner to finish voting.

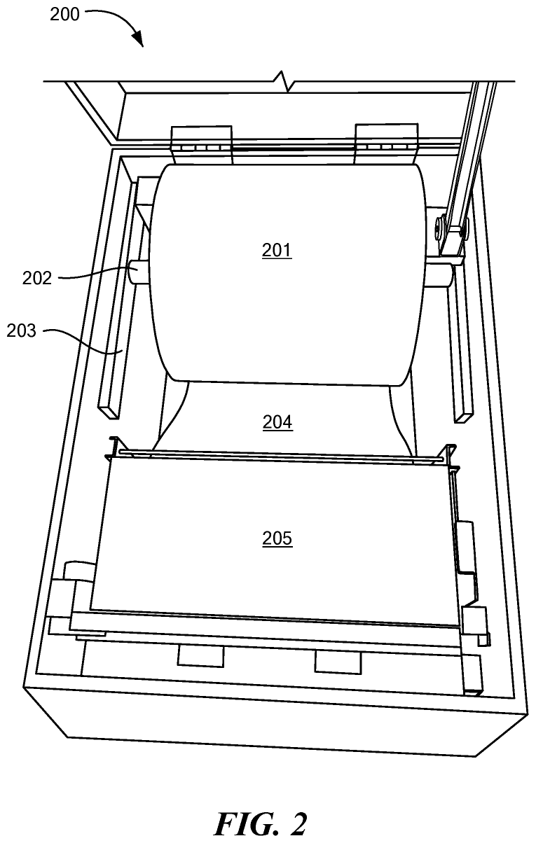

FIG. 2 is a printer diagram top view into enclosure, in accordance with some embodiments. Top-down view 200 shows paper roll 201 mounted on shaft 202, which is coaxially mounted with locking mechanism 203. Paper 204 is a portion of paper roll 201 that hangs off of the paper roll and is fed into printer module 205. A motorized synchronized friction drive is used for feeding paper between the dual print heads, with rubber or other high-friction rollers being used to grip the paper and feed it into printer module 205. In some embodiments, two or more synchronized rollers, including one on each edge of the paper, are used to feed the paper. In other embodiments, a pair of drum rollers is used to feed the paper. Roller speed is controlled by the printer software and/or firmware, in some embodiments. A paper roll with an 8.5″ width is enabled to be used, with an outer diameter of up to 8″, in some embodiments. The shaft 102 is configured to support a paper roll of at least 11.5 pounds.

A cutter is incorporated into embedded printer 205, in some embodiments, and may be configured in software to cut the completed ballots into any desired size. This is desirable as different regions or voting jurisdictions may have different requirements or preferences concerning the size of paper to be used, and additionally the use of specially sized paper may be advantageous for election security, such that the use of a roll of paper combined with a cutter enables a single ballot marking system to be used for multiple different elections with different requirements.

In an alternate embodiment, individual sized sheets of paper may be supported, using a paper tray and paper feed mechanism and configured to feed individual sheets into the printer module 205. In an alternate embodiment, the printer module may be configured separately from an all-in-one voting device, for example, in a printer-only configuration to enable election administrators to preprint ballots for use on a day of an election.

In some embodiments, the printer may be encapsulated in a metal enclosure to prevent tampering, thus forming a printer module, in some embodiments. The printer module may be secured to the setup case using rails, screws, or other structural components, in some embodiments. The printer module may be physically configured within the ballot marking system such that printed sheets emerge from slot 106 at the front of the setup case, in some embodiments.

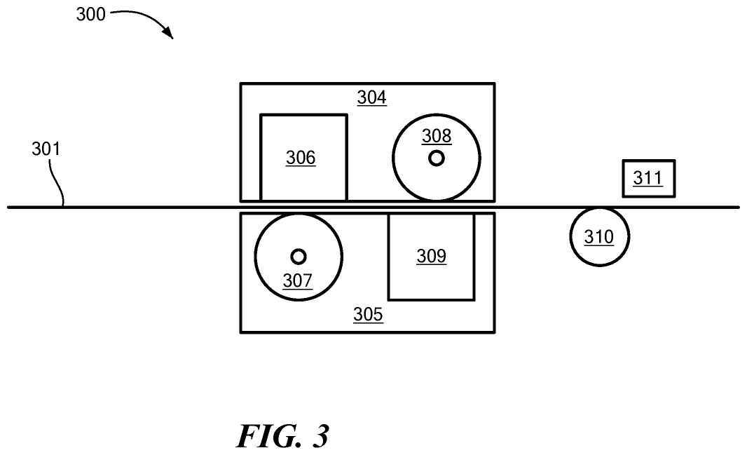

FIG. 3 is an embedded printer mechanism schematic design, in accordance with some embodiments. Printer mechanism 300 is shown in cross-section and in schematic fashion and does not include an enclosure or any structural portions of the design. Paper is fed through paper path 301 through the mechanism between print head module 304 and print head module 305. Within the print head modules, two print heads 306, 309 are used, one on each side of the paper. Print head 306 is aligned with platen 307, and print head 309 is aligned with platen 308. Platen 307 and platen 308 also provide the function of friction rollers, advancing paper through the printer. Paper is printed and passes over roller 310 and is fed under cutter 311, which cuts the paper into sheets.

The print heads are the width of the paper, in some embodiments, and transfer thermal energy to the paper as it passes through the paper path. The platens are positioned on the reverse side of the paper from their respective print heads. The platens hold the paper in contact with the print heads to facilitate energy transfer, and are made of a sufficiently dense and thermally non-reactive material such that they do not heat the reverse side of the paper to produce an image.

The printer may be configured with thermal sensors, in some embodiments, and the system may also be configured to prevent printing when the internal assembly exceeds a certain temperature, or indirectly by limiting the number of pages that can be printed in a minute.

Firmware may be used to control temperature of the print head, in some embodiments. Notable is that the darkness of an image is proportionally related to the amount of power used to heat the print head. Increasing the density increases the amount of power the print heads produce, such that the more density, the more it heats up, resulting in a darker image. Greater temperature of the print head thus increases the power draw. In some embodiments, software is used to enable an operator to configure the firmware to change printer density such that the printer produces an image that is acceptable but does not draw too much power. In some embodiments, acceptable image darkness may be configured based on regulations for a specific voting jurisdiction.

It is also notable that based on the temperature of the print heads, the paper may experience increased friction, and this change in paper velocity may affect dual side image registration. In some embodiments, firmware may be used to enable the configuration of the desired print head temperature. In some embodiments, the thermal characteristics of the paper are matched to the thermal characteristics of the print head. Print speed, energy draw, and print head temperature are correlated to produce a successful printed ballot while meeting desirable imaging and energy requirements, in some embodiments.

Printing shall be enabled on substantially all of the face of the paper, less reasonable or required margins, in some embodiments. In some embodiments, printing is enabled as close as 2.5 mm to each edge of the paper in the direction perpendicular to the paper path. This characteristic of the system is important, as the tabulation process typically depends on the presence of printed timing marks around the edge of the ballot.

The large format direct thermal printing paper has a thermal print coating on both sides, in some embodiments, and is provided in a roll of greater than 8″ in width, in some embodiments. The roll is sized to be loaded as a consumable into a portable ballot printing device including a cutter. A variety of roll widths may be supported, in some embodiments, such as 7, 8, 8.5, 9, 10, and 11 inches wide. The preferred width is 8.5 inches wide. Common supported lengths are 11″, 14″, 17″ but can also be as short as 8″ or 30″ or longer, in some embodiments.

Alignment roller 310 at the end of the paper path allows the printed sheet to emerge from the print path in proper alignment to be cut by cutter 311. Cutter 311 may use a blade drawn across the paper horizontally, perpendicular to the direction of travel of the paper, synchronized to the time the paper exits along the paper path, in some embodiments. The blade may be drawn across the paper path using motorized gears (not shown) on the side of the printer paper path. Cutter 311 may be configured to operate with a paper width of 8.5″, in a preferred embodiment. In some embodiments, the cutter may be provided with the printer module. In some embodiments, the printer may be configured in firmware, software, or both to output sheets of a specified size by cutting the continuous roll of paper. In some embodiments, sheets of US Letter size, US Legal size, or another size may be configured. In some embodiments, software may be configured to allow an operator to select one of a variety of sizes, or may be configured to allow the operator to select a size that corresponds to a number of voting options.

A roll of thermal paper is mounted into the printer and is configured to feed paper into the printer mechanism shown in FIG. 3. The roll of thermal paper is quite heavy and it is desirable for the roll to be secured during transport while remaining in the printer to avoid unspooling or crumpling of the paper in transit.

The printer is configured within an enclosure, the enclosure being also configured to hold within it a roll of paper in alignment with a feeding mechanism of the printer using an axial roll holder mounted on two inner sides of the mounting box. In some embodiments, a paper roll locking mechanism may also be provided. In some embodiments, the paper roll locking mechanism may have a manual knob for operation disposed outside of the mounting box. In some embodiments, the manual knob may be physically coupled to the locking mechanism within the box such that turning the manual knob allows an operator to lock or unlock the paper roll locking mechanism. Entry to the enclosure may be secured with a keyed entry lock. The enclosure may in turn be mounted to the interior of a ballot marking system setup case, in some embodiments using screws that mount to pull-out rails, in some embodiments disposed towards the bottom of the setup case. In some embodiments the enclosure material may be steel or aluminum. In some embodiments, another material that is not metal may be used.

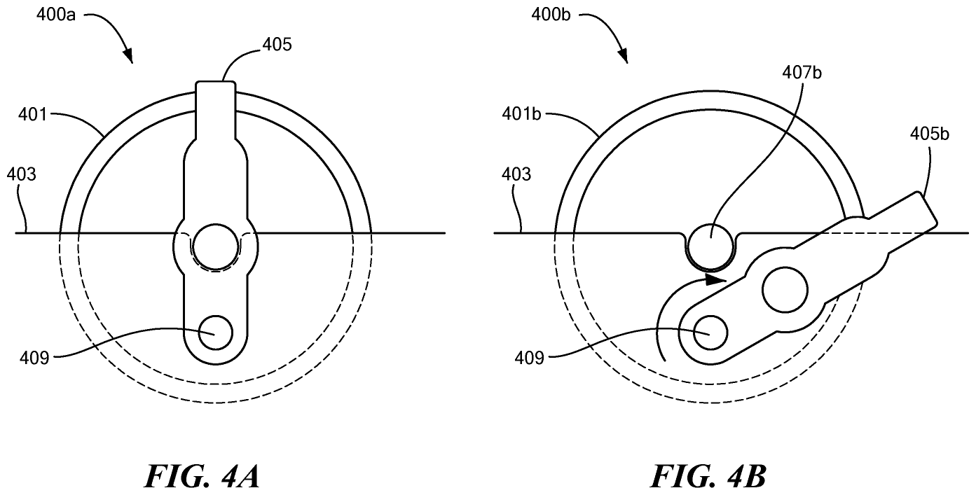

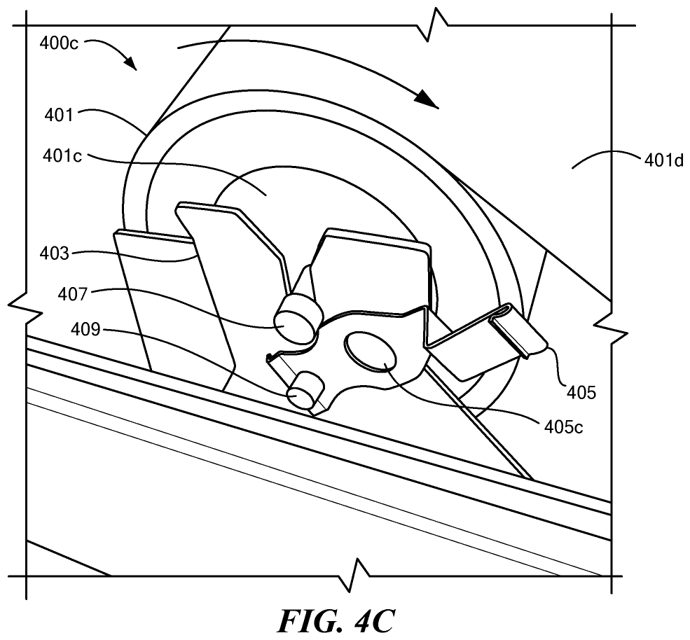

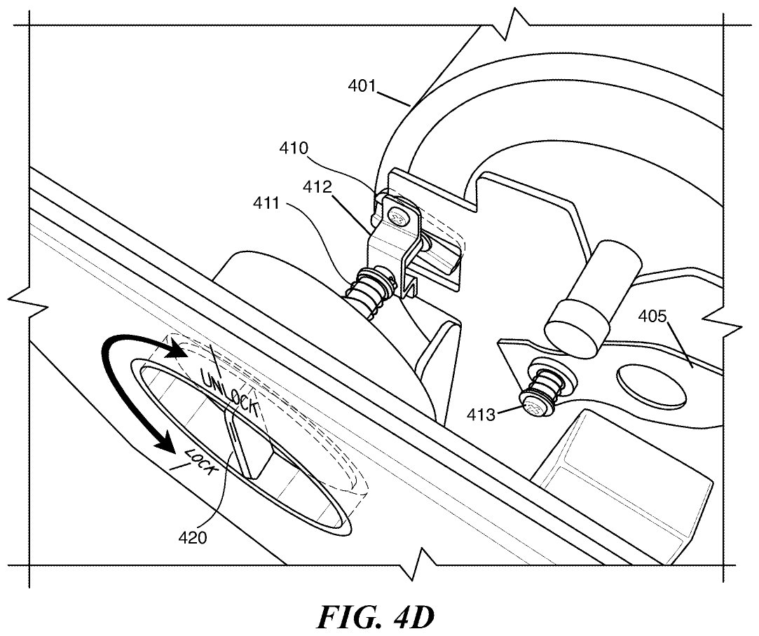

FIGS. 4A and 4B are alternative views of a paper axle hold down lock design, in accordance with some embodiments. FIG. 4A shows an engaged state 400a and FIG. 4B shows a disengaged state 400b. Paper roll 401 is mounted on axial roll holder 407b, which fits into a slot in sidewall mounting plate 403 and is free to spin along with the paper roll. Paper roll 401 is further secured as follows by retaining clip 405, which is axially mounted on bolt 409. Bolt 409 is coupled to sidewall mounting plate 403. FIG. 4A shows retaining clip 405 in an engaged position, where the end of retaining clip 405 is bent such that it is configured to hold paper roll 401 in place vertically; as well, when in an engaged position, the central hole of retaining clip 405 also is clipped onto the end of axial roll holder 407b to function as a hold-down. Retaining clip 405 is also called hold-down clip in this disclosure. Retaining clip 405, even in an engaged position, permits rotation of the paper roll and permits ordinary operation of the printer. In FIG. 4B, retaining clip 405 is in an disengaged position, allowing paper roll 401b to be extracted together with axial roll holder 407b. In some embodiments, axial roll holder 407b may be coupled to the paper roll while outside of the printer module prior to reloading; in other embodiments, axial roll holder 407b may be coupled to a sidewall (not shown) on another side of the printer module and paper roll 401 may slide onto it. To exchange or secure a paper roll, the retaining clip 405 is manually moved into or out of the engaged position. Axial roll holder 407b is shown in a top-down view in FIG. 2 as 202 and in FIG. 4C as 407. A brake mechanism, shown in FIG. 4D, also prevents paper roll 401 from moving, as further described below.

FIG. 4C is an additional alternative view of a paper roll axle hold down lock design, in accordance with some embodiments. View 400c is a perspective view of a paper roll axle hold down lock design from above and to the side in an disengaged state but such that paper roll 401 is properly seated. Paper roll 401 is mounted on axial roll holder 407. Paper roll core 401c is also shown together with paper roll 401. A top sheet of paper 401d is shown being fed off of the paper roll and into the printer module. It is desirable for the paper roll to be held down during transport such that the paper roll core 401c and axial roll holder 407 does not separate from the sidewall mounting plate 403. Hole 405c is configured to line up with axial roll holder 407, such that hold-down clip 405 may be secured tightly against sidewall mounting plate 403 when in the engaged position. To exchange or remove a paper roll, a user may manually pull hold-down clip 405 away from and off of axial roll holder 407 to remove the paper roll 401 from its seated position, and may reverse the operation to secure or hold down the paper roll by manually pulling hold-down clip 405 away from the paper roll and seating axial roll holder 407 inside the hole 405c in hold-down clip 405 to hold down the paper roll, in some embodiments. Hold-down clip 405 is able to be repositioned due to its being coupled with spring assembly 413 (shown in FIG. 4D), in some embodiments. Axial roll holder 407 is shown in a top-down view in FIG. 2 as 202. A brake mechanism, shown in FIG. 4D, also prevents paper roll 401 from moving, as further described below.

FIG. 4D is a perspective view of a paper roll brake design, in accordance with some embodiments. While paper roll 401c is held down by hold-down clip 405 as shown in FIG. 4C, it is additionally desirable for the paper roll to be held in place and prevented from rotating during transport such that additional paper does not feed off of the paper roll and therefore so that top sheet 401d does not crinkle, although the paper roll brake should be disengaged when printing is actively being performed. Paper roll 401 is held in place and prevented from rotating using a brake mechanism, described as follows. Brake pad 410 is enabled to make contact with paper roll 401 by brake pad spring screw 411 (which is held in place by fixed brake pad bracket 412), causing it to make contact with the paper roll and prevent it from rotating. Knob 420 is manually operable from an exterior of the printer module, such that when in an unlocked position knob 420 disengages the brake pad and allows unimpeded motion of the paper roll, e.g., for normal paper feeding during printing, and when in a locked position, knob 420, together with brake pad spring screw 411, engages the brake pad such that it is pressed against the paper roll. FIG. 4D shows the brake pad 410 and hold-down clip 405 each in an unlocked or disengaged position.

The paper is suitable for dual-sided direct thermal printing, in some embodiments, as further described below.

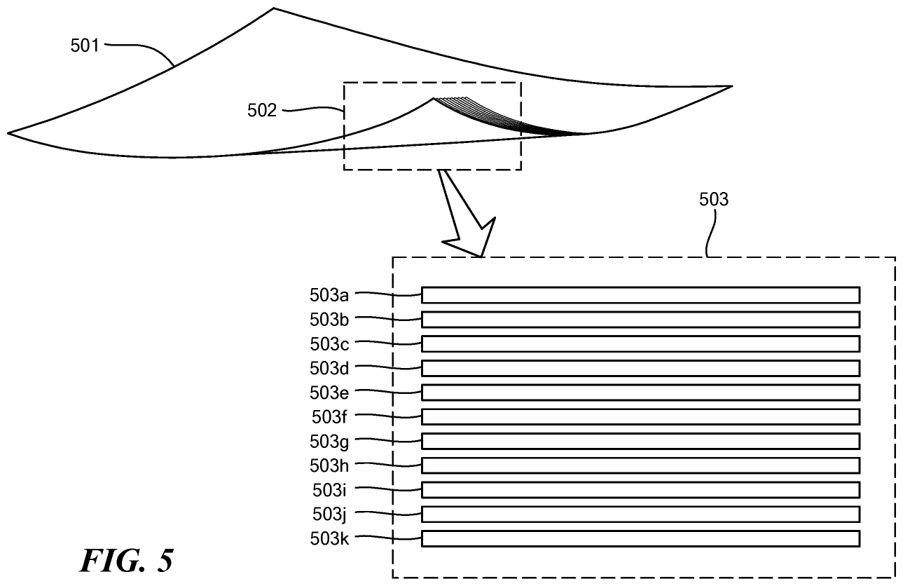

FIG. 5 is a cross-sectional cutaway view of a portion of a suitable printing medium, in accordance with some embodiments. Sheet 501 has been cut from a roll of paper. Inset region 502 is shown in magnified view 503. The paper may be based on a cellulosic fiber core or substrate, combined with thermal printing coatings on the front and back side (first and second side).

The layers of the paper, in one embodiment, are as follows: top coating 503a; thermal color change chemistry 503b; primer 503c; base paper 503d; protective back coating 503e; adhesive 503f; protective back coating 503g; base paper 503h; primer 503i; thermal color change chemistry 503j; and top coating 503k. The protective back coatings enable the paper to be adhered together. The top coatings enable scratch and friction resistance, suitable for repeated handling and long-term storage. A variety of materials can be used for the heat change material/thermal color change chemistry, such as a lueco dye, or a lueco dye as combined with appropriate co-reactant chemicals and sensitizers, such as those disclosed in U.S. Pat. No. 5,883,043 issued Mar. 16, 1999, hereby incorporated by reference. The base paper may be formed in the form of a nonwoven web of natural cellulosic or other fibrous material by air-forming, wet-forming, or another paper making process. The two base papers may be separately covered with the other coatings and mixtures, and then adhered back-to-back, in some embodiments. In alternate embodiments, a single base paper may be used with coatings 503a, 503b, 503c applied to a first side of the single base paper and coatings 503i, 503j, and 503k applied to a second side of the single base paper. The layers of the paper may be applied using any suitable means, such as flooding and metering and subsequently drying, or spraying or dipping etc. Generally, coatings on the paper are less than 0.001 inch thick. Dynamic and static sensitivity of the paper may be designed such that the thermal printing process has high print quality (e.g., high contrast and dark black levels), moderate electricity usage (e.g., using as low a temperature as needed), and good color change speed that is suitable for the elections use case (e.g., the speed required for a full page print is less than that required for some high-speed receipt printers). Specifically, in a preferred embodiment, a static sensitivity 70° number of ≤0.25, a dynamic sensitivity of ≥1.10, and a brightness grade of ≥8 is provided, with the greatest thermal paper sensitivity during printing (dynamic sensitivity) being within the range of 4-10 mJ/mm², and with a corresponding optical density change between 0.1 and 1.2 (fully developed).

In some embodiments, security characteristics could be provided in or on the paper to enhance election security, such as special black light, ultraviolet (UV), or infrared (IR) codes, holographic seals, watermarks, or preprinted barcodes. In some embodiments, the paper may come with indicia of its chain of custody, also for enhancing election security, chain of custody, and inventory management.

In some embodiments, a printer supports standard page description languages, which may include any of the following: HTML, XML, PostScript, PDF, LaTeX, Microsoft Word, plain text, or any other electronic form of page description. In some embodiments, the printer may receive a ballot specified in a file or a bit stream in a standard page description language, which may be referred to as a ballot printer description file, and wherein the specification for the document includes pages, and wherein the pages are formatted using a ballot marking or printing application. The ballot marking application may accept input from a user (e.g., a voter) to indicate his or her selections from the set of possible vote selections defined for a particular election, which is a logical representation of a ballot. The output of the ballot marking application may use the voter input combined with the logical ballot and information about the ballot layout to generate a page image, and may send the page image to the printer in a page description language as identified herein, in some embodiments. In some embodiments, the ballot printing application may be operated by an election administrator or poll worker, to generate and print one or more blank paper ballots using the printer.

Ballot marking and printing software, page generation software, print preview, and touchscreen input may be features present on the CPU that are enabled via the touchscreen and other user input devices.

In some embodiments, features that support full-face ballot printing are supported. Timing marks may be inserted by the image generation software into the print image before printing. A cutter is provided in conjunction with a roll paper feed mechanism that cuts the paper at an appropriate size, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A thermal ballot printer for producing double-sided full-face thermal printed voting ballots, comprising:
a first thermal print head disposed on a first side of a print path, the print path being configured to receive an end of a roll-fed thermal print medium;
a second thermal print head disposed on a second side of a print path; and
a cutter disposed on the first side of the print path and configured to cut printed sheets.

2. The thermal ballot printer of claim 1, wherein the print path is configured to accept a roll-fed thermal print medium of between 7″ and 9″ in width.

3. The thermal ballot printer of claim 1, further comprising a paper roll brake configured to hold a roll of thermal paper in a first configuration suitable for use by the printer in an operational mode; and in a second locked configuration suitable for secure transport of the roll of thermal paper while mounted to the locking paper roll holder.

4. The thermal ballot printer of claim 1, further comprising a paper roll brake configured to make contact with a roll of thermal paper to prevent the roll of thermal paper from rotating.

5. The thermal ballot printer of claim 1, further comprising a paper roll axle hold-down configured to maintain physical coupling between a mounting axle for a roll of thermal paper with the thermal ballot printer while permitting rotation for the roll of thermal paper during operation of the thermal ballot printer.

6. The thermal ballot printer of claim 1, wherein the thermal ballot printer is electrically coupled to a battery system equipped to provide one or both of battery backup power or battery operating power to the thermal ballot printer.

7. The thermal ballot printer of claim 1, further comprising a digital interface for receiving a ballot printer description file of two or more pages in length and a processor for assigning a first page of the received ballot printer description file to the first thermal print head and for assigning a second page of the received ballot printer description file to the second thermal print head.

8. The thermal ballot printer of claim 1, wherein the first thermal print head is disposed opposite a first roller platen on the second side of the print path and wherein the second thermal print head is disposed opposite a second roller platen on the first side of the print path.

9. The thermal ballot printer of claim 1, further comprising a firmware configured to receive instructions to heat the first thermal print head to a first state change temperature during operation and the second thermal print head to a second state change temperature during operation.

10. The thermal ballot printer of claim 1, wherein the first state change temperature and the second state change temperature are configured to enable printing of double-sided ballots in synchronized fashion.

11. The thermal ballot printer of claim 1, wherein the first thermal print head and the second thermal print head are direct thermal print heads.

12. The thermal ballot printer of claim 1, wherein the thermal ballot printer is configured to communicate with software, the software for receiving a voter's intent via one or more of a touchscreen and an assistive input device, and for rendering a printed ballot image.

13. A ballot marking system, comprising:
an enclosure;
a user-operated touchscreen device for enabling a user to indicate vote selections; and
a double-sided full-face thermal ballot printer.

14. The ballot marking system of claim 13, wherein the user-operated touchscreen device is operable by a voter to print a filled-in ballot reflecting the vote selections using the double-sided full-face thermal ballot printer.

15. The ballot marking system of claim 13, wherein the user-operated touchscreen device is operable by an election administrator to print a blank ballot using the double-sided full-face thermal ballot printer.

16. The ballot marking system of claim 13, further comprising a secure paper roll holder with two configurations, the secure paper roll holder having a first configuration for feeding a roll of double-sided thermal paper into the double-sided full-face thermal ballot printer, and a second configuration for securely holding the roll of double-sided thermal paper without unspooling during transport, the second configuration further comprising a brake.

17. The ballot marking system of claim 13, further comprising a battery for battery backup-based operation of the ballot marking system.

18. The ballot marking system of claim 13, further comprising a cutter for cutting ballots emitted by the double-sided full-face thermal ballot printer, and a slot in the enclosure situated at an end of a paper path of the double-sided full-face thermal ballot printer.

19. The ballot marking system of claim 13, further comprising at least one assistive input device for enabling a voter to indicate vote selections, and wherein the at least one assistive input device comprises one or more of a keypad, a rocker paddle, and a sip and puff device.

20. The ballot marking system of claim 13, the double-sided full-face thermal ballot printer configured to use a roll of double-sided direct thermal paper having a width of 8.5″.
